(19) United States
(12) Patent Application Publication
(10) Pub. No.: US 2024/0111297 A1
(43) Pub. Date: Apr. 4, 2024

(54) TRAVEL CONTROL SYSTEM, TRAVEL CONTROL METHOD, AND COMPUTER PROGRAM

(71) Applicant: YAMAHA HATSUDOKI KABUSHIKI KAISHA, Iwata-shi (JP)

(72) Inventor: Masaki MASUDA, Shizuoka (JP)

(21) Appl. No.: 18/373,339

(22) Filed: Sep. 27, 2023

(30) Foreign Application Priority Data
Sep. 30, 2022 (JP) 2022-158586

(51) Int. Cl. G05D 1/02; A01B 76/00

(52) U.S. Cl. CPC G05D 1/024; A01B 76/00; G05D 2201/0201

(57) ABSTRACT

A travel control system to control traveling of a vehicle includes a sensor to sense an environment around the vehicle and output sensor data, and a controller configured or programmed to detect an object around the vehicle based on the sensor data, and to control traveling of the vehicle depending on a result of the object detection. The sensor data includes three-dimensional point cloud data. The controller is configured or programmed to obtain data of points from the three-dimensional point cloud data, count a number of points in each of predetermined angular ranges as viewed from above in a height direction of the vehicle, and perform a control to put the vehicle into a travel stopped state depending on the counted number of the points.

### CROSS REFERENCE TO RELATED APPLICATIONS

This application claims the benefit of priority to Japanese Patent Application No. 2022-158586 filed on Sep. 30, 2022. The entire contents of this application are hereby incorporated herein by reference.

### BACKGROUND OF THE INVENTION

### 1. Field of the Invention

The present invention relates to travel control systems, travel control methods, and non-transitory computer readable mediums including computer programs.

### 2. Description of the Related Art

Automated and unmanned work vehicles for use in fields have in recent years been being studied and developed. Some work vehicles that travel autonomously by utilizing a positioning system such as the global navigation satellite system (GNSS) have become practical. A work vehicle that travels while detecting objects therearound using a range sensor such as a light detection and ranging (LiDAR) sensor has been being developed.

For example, Japanese Laid-Open Patent Publication No. 2019-154379 discloses a work vehicle that travels autonomously between crop rows in a field using a LiDAR sensor.

There is a demand for an increase in the convenience of vehicles that use a range sensor, such as a LiDAR sensor.

### SUMMARY OF THE INVENTION

Preferred embodiments of the present invention provide travel control systems, travel control methods, and non-transitory computer readable mediums including computer programs as follows.

According to a preferred embodiment of the present invention, a travel control system for controlling traveling of a vehicle includes a sensor to sense an environment around the vehicle and output sensor data, and a controller configured or programmed to detect an object around the vehicle based on the sensor data, and control traveling of the vehicle depending on a result of the object detection, wherein the sensor data includes three-dimensional point cloud data, and the controller is configured or programmed to obtain data of a plurality of points from the three-dimensional point cloud data, count a number of points in each of a plurality of predetermined angular ranges as viewed from above in a height direction of the vehicle, and perform a control to put the vehicle into a travel stopped state depending on the counted number of points.

In the vicinity of the sensor, there may be a dead zone in which data of a sufficient number of points to detect an object is not obtained. When an object is present in such a dead zone, none or only a small amount of data of points may be obtained in a range in which the object is present, and therefore, it may be difficult to detect the object.

According to a preferred embodiment of the present invention, the number of points is counted in each of a plurality of predetermined angular ranges, and a control is performed so as to put the vehicle into the travel stopped state depending on the counted number of points. For example, when the number of points is small, the vehicle is not permitted to travel and is caused to stop traveling. When the vehicle is not moving, the vehicle is maintained at rest.

As a result, the vehicle is prevented from continuing to travel even when an object is present in the vicinity of the vehicle but the object is present in the dead zone of the sensor, and therefore, data of a sufficient number of points to detect the object is not obtained.

In a travel control system according to a preferred embodiment of the present invention, the controller is configured or programmed to detect an area having the predetermined angular range in which the counted number of points is less than a first predetermined number, detect a group including consecutive ones of the detected areas in which a number of consecutive ones of the detected areas is at least a second predetermined number, and perform a control to put the vehicle into the travel stopped state when the total number of the detected areas included in the detected group or groups is at least a third predetermined number.

By using the number of consecutive areas having a predetermined angular range in which a small number of points are present, the vehicle is prevented from being put into the travel stopped state when there are only a small number of consecutive areas due to noise or the like.

When the total number of areas having a predetermined angular range in which a small number of points are present is at least the third predetermined number, a control is performed so as to put the vehicle into the travel stopped state. As a result, the vehicle is prevented from continuing to travel even when data of a sufficient number of points to detect an object in the dead zone is not obtained.

In a travel control system according to a preferred embodiment of the present invention, the controller is configured or programmed to perform a control to put the vehicle into the travel stopped state when the total number of the areas included in one of the detected groups is at least the third predetermined number.

When the number of consecutive areas having a predetermined angular range in which a small number of points are present is at least the third predetermined number, a control is performed so as to put the vehicle into the travel stopped state. As a result, the vehicle is prevented from continuing to travel even when data of a sufficient number of points to detect an object in the dead zone is not obtained.

In a travel control system according to a preferred embodiment of the present invention, the controller is configured or programmed to perform a control to put the vehicle into the travel stopped state when the total number of the areas included in at least two of the detected groups is at least the third predetermined number.

By using the total number of areas having a predetermined angular range in which a small number of points are present, the vehicle is prevented from continuing to travel even when there are two or more separate groups of such areas due to the shape of an object, the position of an object, and the like.

In a travel control system according to a preferred embodiment of the present invention, the controller does not perform a control to put the vehicle into the travel stopped state, depending on the counted number of points, when the group is not detected.

As a result, the vehicle is prevented from being put into the travel stopped state when there is only one area or only a small number of consecutive areas in which the number of points is small due to noise or the like.

In a travel control system according to a preferred embodiment of the present invention, the controller does not perform a control to put the vehicle into the travel stopped state, depending on the counted number of points, when the total number of the areas included in all of the detected groups is less than the third predetermined number.

As a result, the vehicle is prevented from being put into the travel stopped state when there are only a small number of areas in which the number of points is small due to noise or the like.

In a travel control system according to a preferred embodiment of the present invention, the controller is configured or programmed to obtain data of a plurality of measurement points indicated by the three-dimensional point cloud data as the data of the plurality of points, count a number of the measurement points in each of the plurality of predetermined angular ranges as viewed from above, and perform a control to put the vehicle into the travel stopped state depending on the counted number of measurement points.

The vehicle is prevented from continuing to travel even when an object is present in the vicinity of the vehicle but the object is present in the dead zone of the sensor, and therefore, data of a sufficient number of points to detect the object is not obtained.

In a travel control system according to a preferred embodiment of the present invention, the controller is configured or programmed to divide a space in which the plurality of measurement points indicated by the three-dimensional point cloud data are distributed into a plurality of voxels, determine a representative point for each voxel in which at least one of the measurement points is present, obtain data of the plurality of representative points as the data of the plurality of points, count a number of the representative points that are present in each of the plurality of predetermined angular ranges as viewed from above, and perform a control to put the vehicle into the travel stopped state depending on the counted number of representative points.

The vehicle is prevented from continuing to travel even when an object is present in the vicinity of the vehicle but the object is present in the dead zone of the sensor, and therefore, data of a sufficient number of points to detect the object is not obtained.

In a travel control system according to a preferred embodiment of the present invention, the sensor includes a LiDAR sensor.

The vehicle is prevented from continuing to travel even when an object is present in the vicinity of the vehicle but the object is present in the dead zone of the LiDAR sensor, and therefore, data of a sufficient number of points to detect the object is not obtained.

According to a preferred embodiment of the present invention, a vehicle includes a travel control system according to a preferred embodiment of the present invention described above.

The vehicle is prevented from continuing to travel even when an object is present in the vicinity of the vehicle but the object is present in the dead zone of the sensor, and therefore, data of a sufficient number of points to detect the object is not obtained.

In a vehicle according to a preferred embodiment of the present invention, the vehicle is a mobile agricultural machine.

The vehicle is prevented from continuing to travel even when an object is present in the vicinity of the vehicle during work in a field but the object is present in the dead zone of the sensor, and therefore, data of a sufficient number of points to detect the object is not obtained.

A vehicle according to a preferred embodiment of the present invention includes a drive to cause the vehicle to travel, wherein the controller is configured or programmed to control operation of the drive so as to cause the vehicle to perform autonomous driving.

The vehicle that performs autonomous driving is prevented from continuing to travel even when an object is present in the vicinity of the vehicle but the object is present in the dead zone of the sensor, and therefore, data of a sufficient number of points to detect the object is not obtained.

In a travel control system according to a preferred embodiment of the present invention, the predetermined angular range is at least one degree and at most two degrees.

The number of points is counted in each relatively narrow angular range, and therefore, a range in which the number of points is small is identified with high precision.

In a travel control system according to a preferred embodiment of the present invention, the first predetermined number is at least two and at most five.

As a result, an area having a predetermined angular range in which the number of points is small is detected.

In a travel control system according to a preferred embodiment of the present invention, the second predetermined number is at least two and at most five.

As a result, the vehicle is prevented from being put into the travel stopped state when there are only a small number of consecutive areas having a predetermined angular range in which the number of points is small due to noise or the like.

In a travel control system according to a preferred embodiment of the present invention, the third predetermined number is at least six.

A control is performed so as to put the vehicle into the travel stopped state depending on the total number of areas having a predetermined angular range in which the number of points is small. Therefore, the vehicle is prevented from continuing to travel even when data of a sufficient number of points to detect an object present in the dead zone is not obtained.

According to a preferred embodiment of the present invention, a travel control method for controlling traveling of a vehicle including a sensor to sense an environment around the vehicle and output sensor data including three-dimensional point cloud data includes obtaining data of a plurality of points from the three-dimensional point cloud data, counting a number of the points in each of a plurality of predetermined angular ranges as viewed from above in a height direction of the vehicle, and performing a control to put the vehicle into a travel stopped state depending on the counted number of points.

In the vicinity of the sensor, there may be a dead zone in which data of a sufficient number of points to detect an object is not obtained. When an object is present in such a dead zone, none or only a small amount of data of points may be obtained in a range in which the object is present, and therefore, it may be difficult to detect the object.

According to a preferred embodiment of the present invention, the number of points is counted in each of the plurality of predetermined angular ranges, and a control is performed so as to put the vehicle into the travel stopped state depending on the counted number of points. For example, when the number of points is small, the vehicle is not permitted to travel and is caused to stop traveling. When the vehicle is not moving, the vehicle is maintained at rest.

As a result, the vehicle is prevented from continuing to travel even when an object is present in the vicinity of the vehicle but the object is present in the dead zone of the sensor, and therefore, data of a sufficient number of points to detect the object is not obtained.

According to a preferred embodiment of the present invention, a non-transitory computer readable medium including a computer program to cause a computer to execute a process of controlling traveling of a vehicle including a sensor to sense an environment around the vehicle and output sensor data including three-dimensional point cloud data includes obtaining data of a plurality of the points from the three-dimensional point cloud data, counting a number of the points that are present in each of a plurality of predetermined angular ranges as viewed from above in a height direction of the vehicle, and performing a control to put the vehicle into a travel stopped state depending on the counted number of points.

In the vicinity of the sensor, there may be a dead zone in which data of a sufficient number of points to detect an object is not obtained. When an object is present in such a dead zone, none or only a small amount of data of points may be obtained in a range in which the object is present, and therefore, it may be difficult to detect the object.

According to a preferred embodiment of the present invention, the number of points is counted in each of the plurality of predetermined angular ranges, and a control is performed so as to put the vehicle into the travel stopped state depending on the counted number of points. For example, when the number of points is small, the vehicle is not permitted to travel and is caused to stop traveling. When the vehicle is not moving, the vehicle is maintained at rest.

As a result, the vehicle is prevented from continuing to travel even when an object is present in the vicinity of the vehicle but the object is present in the dead zone of the sensor, and therefore, data of a sufficient number of points to detect the object is not obtained.

In the vicinity of a sensor that senses an environment around a vehicle, there may be a dead zone in which data of a sufficient number of points to detect an object is not obtained. When an object is present in such a dead zone, none or only a small amount of data of points may be obtained in a range in which the object is present, and therefore, it may be difficult to detect the object.

According to a preferred embodiment of the present invention, a control is performed so as to count the number of points in each of the plurality of predetermined angular ranges, and put the vehicle into a travel stopped state depending on the counted number of points. For example, when the number of points is small, the vehicle is not permitted to travel and is caused to stop traveling. When the vehicle is not moving, the vehicle is maintained at rest.

As a result, the vehicle is prevented from continuing to travel even when an object is present in the vicinity of the vehicle but the object is present in the dead zone of the sensor, and therefore, data of a sufficient number of points to detect the object is not obtained.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a left side view illustrating a vehicle 1 according to a preferred embodiment of the present invention.

FIG. 2 is a diagram illustrating a management system 100 that manages operation of a vehicle 1 according to a preferred embodiment of the present invention.

FIG. 3 is a block diagram illustrating an example of a configuration of a vehicle 1 according to a preferred embodiment of the present invention.

FIG. 4 is a diagram illustrating an example of a field 40 in which a vehicle 1 according to a preferred embodiment of the present invention travels.

FIG. 5 is a diagram illustrating an example of a sensing range 120 sensed by a LiDAR sensor 22 according to a preferred embodiment of the present invention.

FIG. 6 is a diagram illustrating an example of a sensing range 120 sensed by a LiDAR sensor 22 according to a preferred embodiment of the present invention.

FIG. 7 is a diagram illustrating an example of an environment spreading out in front of a vehicle 1 according to a preferred embodiment of the present invention.

FIG. 8 is a diagram illustrating an example of a plurality of measurement points indicated by three-dimensional point cloud data according to a preferred embodiment of the present invention.

FIG. 9 is a diagram illustrating an example of a three-dimensional space 50 that is divided into a plurality of voxels 52 according to a preferred embodiment of the present invention.

FIG. 10 is a diagram illustrating an example of a plurality of calculated representative points 53 according to a preferred embodiment of the present invention.

FIG. 11 is a diagram illustrating an example of a normal vector 54 at each calculated representative point 53 according to a preferred embodiment of the present invention.

FIG. 12 is a diagram illustrating an example of representative points 53 that are left after removal of representative points 53 corresponding to a relatively flat ground according to a preferred embodiment of the present invention.

FIG. 13 is a diagram illustrating an example of a bounding box according to a preferred embodiment of the present invention.

FIG. 14 is a diagram illustrating an example of a dead zone 121 as viewed above a vehicle 1 in a height direction thereof according to a preferred embodiment of the present invention.

FIG. 15 is a diagram illustrating an example of a dead zone 121 as viewed from a side thereof in a direction parallel to the left-right direction of a vehicle 1 according to a preferred embodiment of the present invention.

FIG. 16 is a diagram illustrating an example of a range 122 in which data of a sufficient number of measurement points 51 is not obtained according to a preferred embodiment of the present invention.

FIG. 17 is a diagram illustrating an example of predetermined angular ranges according to a preferred embodiment of the present invention.

FIG. 18 is a flowchart illustrating an example of a control to put a vehicle 1 into a travel stopped state depending on the counted number of measurement points 51 according to a preferred embodiment of the present invention.

FIG. 19 is a diagram illustrating an example of a state in which the total number of areas 130 included in at least one detected group 135 is at least a third predetermined number according to a preferred embodiment of the present invention.

FIG. 20 is a diagram illustrating another example of a range 122 in which data of a sufficient number of measurement points 51 is not obtained according to a preferred embodiment of the present invention.

FIG. 21 is a diagram illustrating another example of a state in which the total number of areas 130 included in at least one detected group 135 is at least a third predetermined number.

FIG. 22 is a flowchart illustrating an example of control to put a vehicle 1 into a travel stopped state depending on the counted number of representative points 53 according to a preferred embodiment of the present invention.

### DETAILED DESCRIPTION OF THE PREFERRED EMBODIMENTS

Preferred embodiments of the present invention will be described below with reference to the accompanying drawings. Like components are indicated by like reference characters, and will not redundantly be described. It should be noted that the preferred embodiments below are merely illustrative, and the present invention is in no way limited the preferred embodiments below.

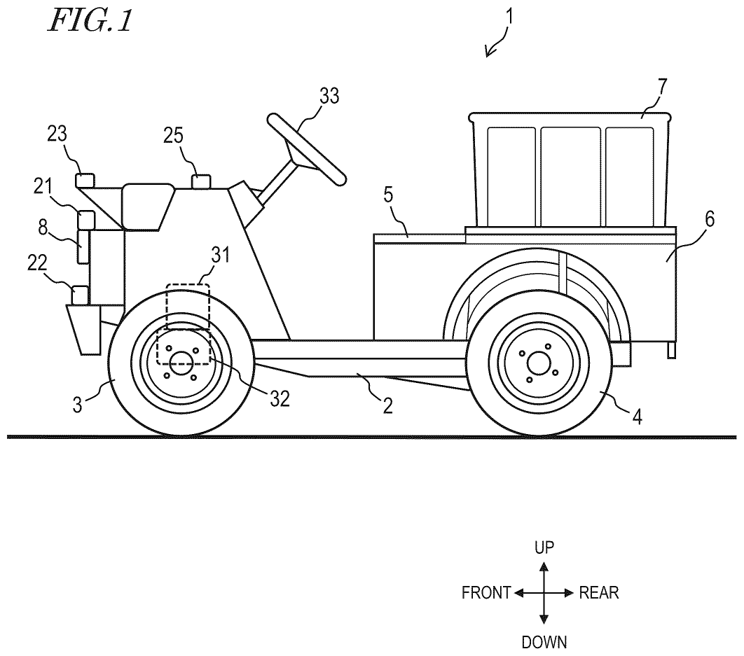

FIG. 1 is a left side view illustrating a vehicle 1 according to a preferred embodiment of the present invention. In the example of FIG. 1, the vehicle 1 is a carrier vehicle for carrying harvested crops in a field. The vehicle 1 is not limited to the carrier vehicle, and may be a mobile agricultural machine that is used in a field, such as a tractor or harvester. The vehicle 1 may also be a buggy such as a golf cart, or may be a general vehicle. An example in which the vehicle 1 is a carrier vehicle for carrying harvested crops in a field will be described below.

The vehicle 1 of the present preferred embodiment can be operated in both a manual operation mode and an autonomous driving mode. In the autonomous driving mode, the vehicle 1 can travel without a human onboard.

As illustrated in FIG. 1, the vehicle 1 includes a vehicle body 2, front wheels 3, rear wheels 4, an engine 31, and a transmission 32. The front wheels 3, the rear wheels 4, the engine 31, and the transmission 32 are provided in the vehicle body 2. One or both of the front wheels 3 and the rear wheels 4 may be a plurality of wheels to which a continuous track is attached (crawler) or a multi-legged walking mobile device, instead of a wheel equipped with a tire.

A seat 5 on which a driver sits is provided at an upper portion of the vehicle body 2. A load bed 6 on which a payload is placed is provided behind the seat 5. In the example of FIG. 1, a basket 7 for carrying harvested crops is placed on the load bed 6. A headlamp 8 is provided at a front portion of the vehicle body 2.

The vehicle 1 includes a LiDAR sensor 21, a LiDAR sensor 22, and a camera 23, which are used to sense an environment around the vehicle 1. In the example of FIG. 1, the LiDAR sensor 21, the LiDAR sensor 22, and the camera 23 are provided at a front portion of the vehicle body 2.

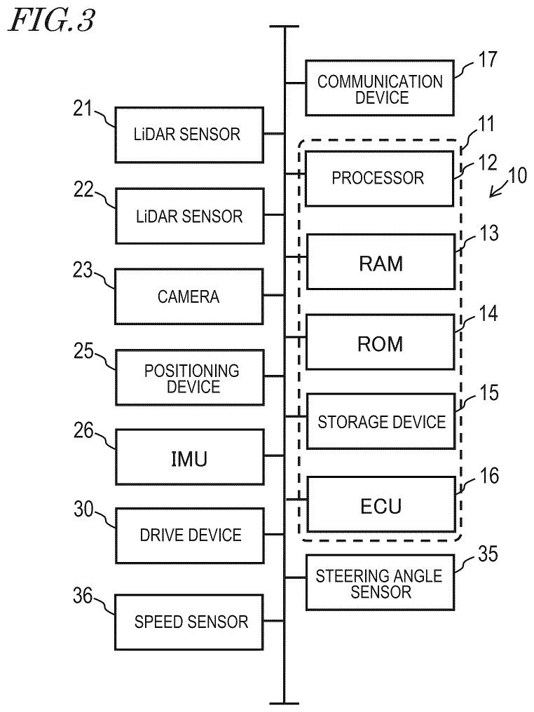

The camera 23 captures an image of an environment around the vehicle 1, and generates image data. The image data generated by the camera 23 is processed by a control device 11 (FIG. 3) of the vehicle 1.

The LiDAR sensors 21 and 22 may be a 3D-LiDAR sensor. The LiDAR sensors 21 and 22 sense an environment around the vehicle 1, and output sensor data. The LiDAR sensor 22 repeatedly outputs sensor data indicating distances and directions to measurement points of objects that are present in a surrounding environment, or three-dimensional coordinate values of the measurement points. The sensor data output from the LiDAR sensors 21 and 22 is processed by the control device 11.

A positioning device 25 is provided at an upper portion of the vehicle body 2. The positioning device 25 detects a position (geographical coordinates) of the vehicle 1 in a geographical coordinate system.

The engine 31 is, for example, an internal combustion engine. The engine 31 may be an electric motor instead of an internal combustion engine. The transmission 32 is able to change the thrust and movement speed of the vehicle 1 by changing gears. The transmission 32 can cause the vehicle 1 to switch between forward movement and backward movement. Rotation generated by the engine 31 is transmitted to the front wheels 3 through the transmission 32. Rotation generated by the engine 31 may be transmitted to the rear wheels 4 or both of the front wheels 3 and the rear wheels 4.

The vehicle 1 is provided with a steering device 33 that includes a steering wheel, a steering shaft connected to the steering wheel, and a power steering device that assists in steering performed using the steering wheel. The front wheels 3 are a steered wheel. By changing the steering angle (angle of turn) of the front wheels 3, the travel direction of the vehicle 1 can be changed. The steering angle of the front wheels 3 can be changed by operating the steering wheel. The power steering device includes a hydraulic device or electric motor that supplies an assistive force for changing the steering angle of the front wheels 3. When automatic steering is performed, the steering angle is automatically adjusted by the force of the hydraulic device or electric motor under the control of the control device 11.

Although the vehicle 1 can be operated by a human, the vehicle 1 may always be operated without a human. In the latter case, the vehicle 1 may not be equipped with components that are necessary only for manned operation such as the seat 5 and the steering wheel. The unmanned vehicle 1 is able to travel autonomously or according to a user's remote control.

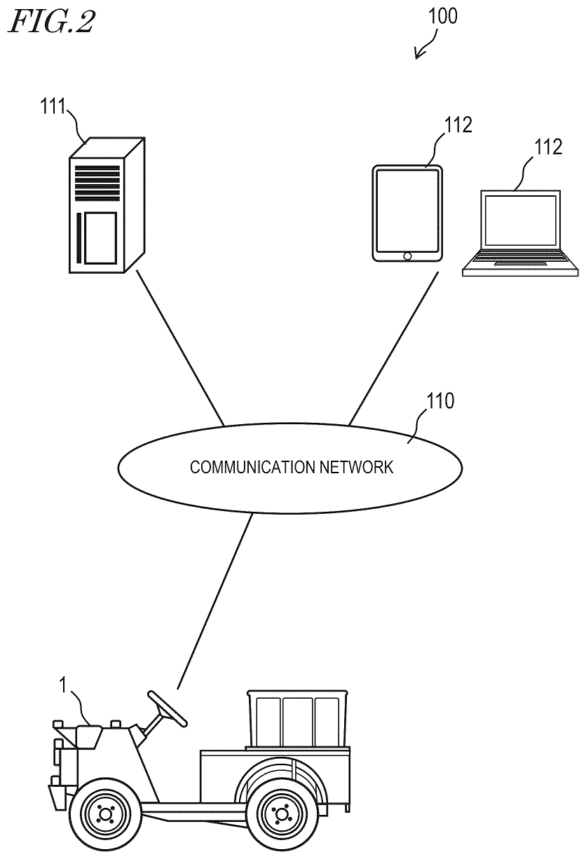

FIG. 2 is a diagram illustrating a management system 100 that manages operation of the vehicle 1. In the management system 100, the vehicle 1, a server computer 111, and a terminal device 112 can communicate with each other through a communication network 110.

The server computer 111 manages operation of the vehicle 1. For example, the server computer 111 generates a work plan of the vehicle 1, and causes the vehicle 1 to work in a field according to the work plan. For example, the server computer 111 generates a target path in a field based on information input by a user using the terminal device 112 or other devices. The server computer 111 may generate and edit a map of an environment based on data obtained by the vehicle 1 or the like using a sensing device such as a LiDAR sensor. The server computer 111 may transmit data of the generated work plan, target path, and environmental map to the vehicle 1, and the vehicle 1 may automatically move and work based on that data.

The terminal device 112 may be a computer that is used by a user who is located away from the vehicle 1. The terminal device 112 is a mobile terminal such as a smart phone or a tablet computer, or a laptop computer. The terminal device 112 may be a stationary computer such as a desktop personal computer (PC). The terminal device 112 displays, on a display, a setting screen to allow the user to input information required to generate a work plan of the vehicle 1. When the user performs an operation of inputting and sending required information on the setting screen, the terminal device 112 transmits the input information to the server computer 111. The server computer 111 generates a work plan based on that information. Furthermore, the terminal device 112 may have the function of displaying, on the display, a setting screen to allow the user to input information required to set a target path. The terminal device 112 may also be used to remotely monitor and operate the vehicle 1. For example, the terminal device 112 is able to display, on the display, a video captured by the camera provided on the vehicle 1.

The work plan, target path, and environmental map may be generated by either the terminal device 112 or a processer included in the vehicle 1. The work plan, target path, and environmental map may be generated by two or more of the vehicle 1, the server computer 111, and the terminal device 112 in a distributed manner.

FIG. 3 is a block diagram illustrating an example of a configuration of the vehicle 1. The vehicle 1 illustrated in FIG. 3 includes a control device 11, a communication device 17, LiDAR sensors 21 and 22, a camera 23, a positioning device 25, an inertia measurement device (IMU) 26, a drive device 30, a steering angle sensor 35, and a speed sensor 36. These components are connected to each other through a bus so that they can communicate with each other. FIG. 3 illustrates components that are highly involved with autonomous driving of the vehicle 1, but not the other components. The control device 11, the LiDAR sensors 21 and 22, the camera 23, the positioning device 25, the IMU 26, the steering angle sensor 35, and the speed sensor 36 may define a travel control system 10 that controls the traveling of the vehicle 1.

The control device 11 may include a processor 12, a random access memory (RAM) 13, a read only memory (ROM) 14, a storage device 15, and an electronic control unit (ECU) 16.

The processor 12 may, for example, be a semiconductor integrated circuit including a central processing unit (CPU). The processor 12 may be implemented by a microprocessor or microcontroller. Alternatively, the processor 12 may be implemented by a field programmable gate array (FPGA), a graphics processing unit (GPU), an application specific integrated circuit (ASIC), an application specific standard product (ASSP), or a combination of two or more selected from these circuits. The processor 12 sequentially executes a computer program stored in the ROM 14, in which instructions for executing one or more processes are written, to carry out desired processes.

The ROM 14 is, for example, a writable memory (e.g., a PROM), a rewritable memory (e.g., a flash memory), or a read-only memory. The ROM 14 stores a program that controls operations of the processor 12. The RAM 13 provides a work area into which a control program stored in the ROM 14 is temporarily loaded during boot-up.

The storage device 15 includes at least one storage medium such as a flash memory or a magnetic disk. The storage device 15 stores data generated by the LiDAR sensors 21 and 22, the camera 23, the positioning device 25, the control device 11, and the like. The data stored in the storage device 15 may include map data (environmental map) of an environment in which the vehicle 1 travels, and data of a target path for autonomous driving. The environmental map includes information about a field in which the vehicle 1 works.

The storage device 15 also stores a computer program for causing the processor 12 and the ECU 16 to execute operations. Such a computer program may be provided to the vehicle 1 through a storage medium (e.g., a semiconductor memory, an optical disc, or the like) or an electrical communication line (e.g., the Internet). Such a computer program may be sold as commercial software.

The drive device 30 includes various devices for enabling the vehicle 1 to travel, such as the engine 31, the transmission 32, the steering device 33, and a brake device. The steering angle sensor 35 measures the steering angle of the front wheels 3, which are a steered wheel. An output signal of the steering angle sensor 35 is used during steering control performed by the control device 11. The speed sensor 36 measures the rotational speed (i.e., the number of revolutions per unit time) of an axle connected to the front wheels 3 or the rear wheels 4. An output signal of the speed sensor 36 is used during travel speed control performed by the control device 11.

The ECU 16 includes a processing circuit including at least one processor. The ECU 16 controls the travel speed and turning movement of the vehicle 1 by controlling the engine 31, the transmission 32, the steering device 33, the brake device, and the like included in the drive device 30. The ECU 16 may be provided in the vehicle 1 as another unit separate from the control device 11.

The communication device 17 communicates with the server computer 111 and the terminal device 112. The communication device 17 may include an antenna and a communication circuit to execute data transmission and reception between communication devices of the server computer 111 and the terminal device 112 through the network 110. Examples of the network 110 include cellular mobile communication networks such as 3G, 4G, or 5G, and the Internet. The communication device 17 may have the function of communicating with a terminal device that is used by a supervisor who is located near the vehicle 1. In that case, communication may be performed in accordance with any wireless communication standard, such as Wi-Fi (registered trademark), cellular mobile communication, or Bluetooth (registered trademark).

The positioning device 25 detects geographical coordinates of the vehicle 1. The positioning device 25 receives satellite signals from a plurality of GNSS satellites, and performs positioning based on the satellite signals. GNSS collectively refers to satellite-based positioning systems, such as the global positioning system (GPS), the quasi-zenith satellite system (QZSS, for example, Michibiki), GLONASS, Galileo, and BeiDou. Positioning may be performed by any technique that can obtain positional information having a required precision. The positioning technique may, for example, be interference positioning or relative positioning.

The inertia measurement device (IMU) 26 includes an acceleration sensor, an angular acceleration sensor, and a magnetic sensor, and outputs a signal indicating a movement amount, an orientation, and an attitude. The IMU 26 can serve as a motion sensor that outputs a signal indicating various quantities of the vehicle 1, such as an acceleration, velocity, displacement, orientation, and attitude. The control device 11 can highly precisely estimate the position and orientation of the vehicle 1 based on a signal output from the IMU 26 in addition to the output signal of the positioning device 25. The positioning device 25 and the IMU 26 may be integrated into a single unit, which may be provided in the vehicle 1.

The processor 12 performs computations and control to achieve autonomous driving based on data output from the positioning device 25, the IMU 26, the camera 23, and the LiDAR sensors 21 and 22. The processor 12 identifies the position and orientation of the vehicle 1 based on output data of the positioning device 25 and the IMU 26.

In the present preferred embodiment, the processor 12 performs ego position estimation and environmental map generation using the sensor data output by the LiDAR sensor 21, and detects objects such as obstacles that are present around the vehicle 1 using the sensor data output by the LiDAR sensor 22. The processor 12 can perform ego position estimation on the vehicle 1 by performing matching between the sensor data output by the LiDAR sensor 21 and the environmental map. The processor 12 may generate or edit the environmental map using an algorithm such as simultaneous localization and mapping (SLAM).

It should be noted that the ego position estimation, environmental map generation, and obstacle detection may be performed using the sensor data output by one of the LiDAR sensors 21 and 22. In that case, the vehicle 1 may include only one of the LiDAR sensors 21 and 22.

The processor 12 may use, in positioning, sensor data obtained by a sensing device such as the camera 23 and/or the LiDAR sensor 21 in addition to the result of positioning performed by the positioning device 25. By correcting or supplementing the satellite signal-based position data using the data obtained by the camera 23 and/or the LiDAR sensor 21, the position of the vehicle 1 can be identified with higher precision. When a satellite signal is not obtained due to a terrain, tree, or the like around the vehicle 1, the position of the vehicle 1 may be estimated by performing matching between sensor data output from the LiDAR sensor 21 and/or the camera 23, and the environmental map.

The processor 12 may determine a destination for the vehicle 1, and a target path from the start point of movement of the vehicle 1 to the target point, based on the work plan stored in the storage device 15.

The ECU 16 controls the drive device 30 based on data of the position and target path of the vehicle 1 such that the vehicle 1 travels along the target path. As a result, the vehicle 1 is allowed to travel along the target path.

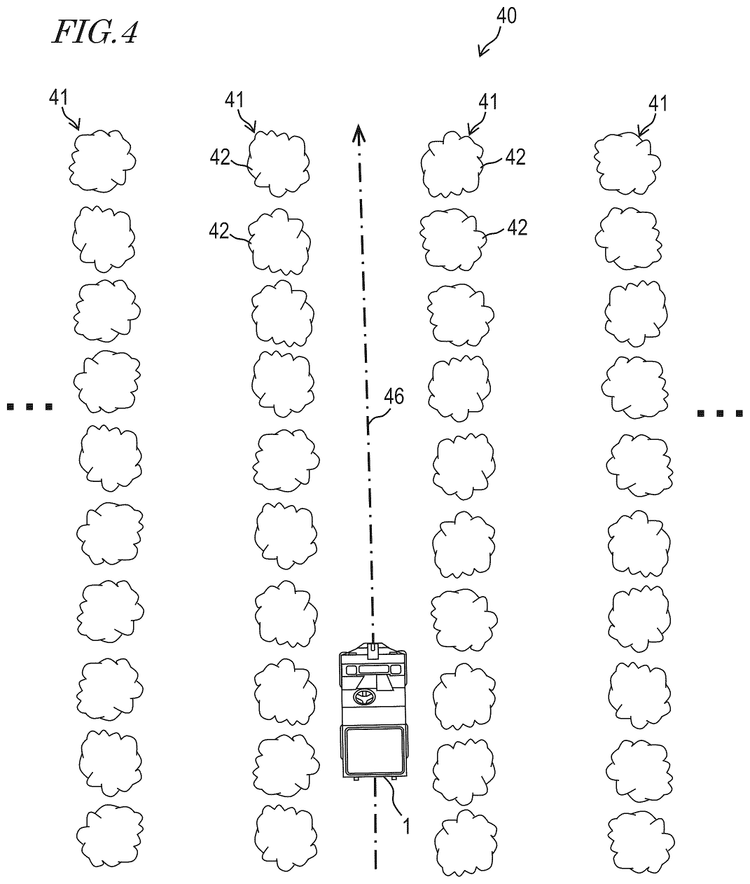

FIG. 4 is a diagram illustrating an example of a field 40 in which the vehicle 1 travels. In this example, the field 40 is a fruit orchard, such as a grape orchard. In the field 40, a plurality of trees 42 are arranged in a plurality of tree rows 41. The vehicle 1 carries harvested crops while traveling along a target path 46 set between tree rows 41. After traveling between a certain pair of tree rows 41, the vehicle 1 may turn around and travel between another pair of tree rows 41. When it is difficult for the vehicle 1 to perform autonomous traveling using the GNSS because the vehicle 1 is hidden by branches and leaves above the vehicle 1, the vehicle 1 is caused to travel while performing ego position estimation by performing matching between the previously prepared environmental map and the sensor data.

As described above, in the present preferred embodiment, objects such as obstacles that are present around the vehicle 1 are detected using the sensor data output by the LiDAR sensor 22. The LiDAR sensor 22, which is provided at a front portion of the vehicle 1, mainly senses an environment spreading out in front of the vehicle 1.

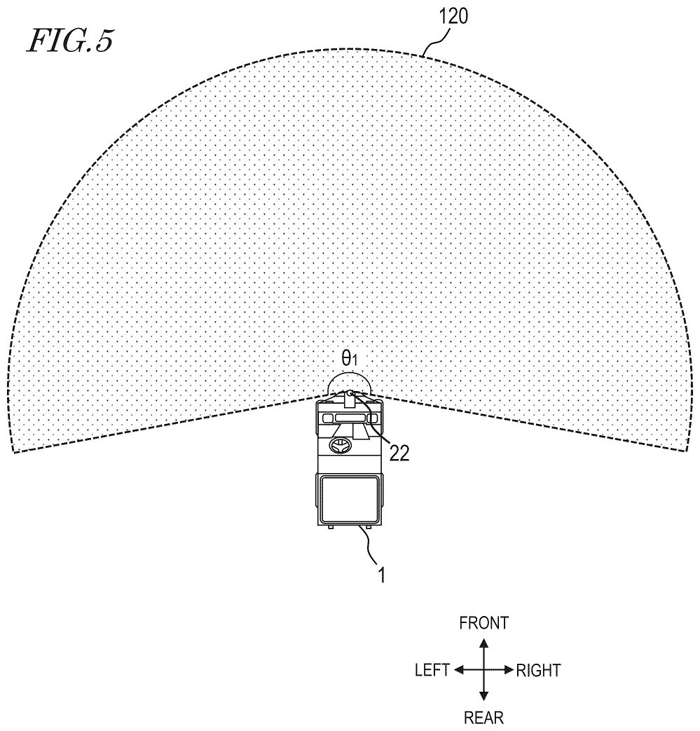

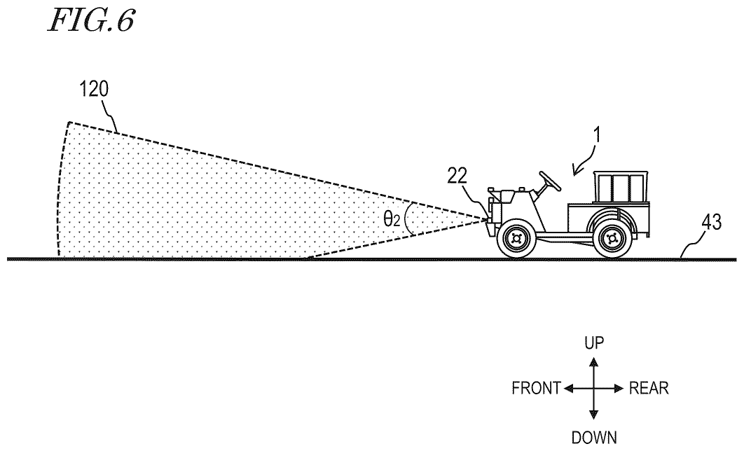

FIGS. 5 and 6 are diagrams illustrating an example of a sensing range 120 that is sensed by the LiDAR sensor 22. FIG. 5 illustrates the sensing range 120 as viewed from above in a vertical direction with the vehicle 1 located on a horizontal ground. FIG. 6 illustrates the sensing range 120 as viewed from a side thereof in a direction parallel to the left-right direction of the vehicle 1.

As illustrated in FIG. 5, the sensing range 120 spreads out over an angle θ₁ from the LiDAR sensor 22 as viewed from above so as to sense a surrounding environment mainly spreading out forward and/or sideward relative to the vehicle 1. The angle θ₁ is, for example, but not limited to, at least 90 degrees and at most 220 degrees. As illustrated in FIG. 6, the sensing range 120 spreads out over an angle θ₂ from the LiDAR sensor 22 as viewed from a side thereof so as to sense a surrounding environment spreading out from a diagonally upward direction to a diagonally downward direction relative to the vehicle 1. The angle θ₂ is, for example, but not limited to, at least 15 degrees and at most 45 degrees.

The LiDAR sensor 22 emits pulses of a laser beam (hereinafter simply referred to as “laser pulses”) in different emission directions one after another. The LiDAR sensor 22 is able to measure a distance to the position of each reflection point from the difference in time between emission of each laser pulse and reception of reflected light thereof. The “reflection point” may be an object that is present in an environment around the vehicle 1.

The LiDAR sensor 22 may measure a distance between the LiDAR sensor 22 and an object by any technique. Examples of the measurement technique of the LiDAR sensor 22 include mechanical rotation, MEMS, and phased array. These measurement techniques differ from each other in the technique of emitting laser pulses (scanning technique). For example, a mechanical rotation type LiDAR sensor scans a surrounding environment in all directions (360 degrees) around the axis of rotation by rotating a cylindrical head thereof for emitting laser pulses and detecting reflected light of the laser pulses. A MEMS type LiDAR sensor scans a surrounding environment in a predetermined angular range around the axis of swinging by swinging the emission direction of laser pulses using a MEMS mirror. A phased array type LiDAR sensor controls the phase of light so as to swing the emission direction of the light, and thus scans a surrounding environment in a predetermined angular range around the axis of the swinging.

The sensing range 120 may be sensed using a single LiDAR sensor 22. Alternatively, the vehicle 1 may include a plurality of LiDAR sensors 22, and may sense the sensing range 120 using the plurality of LiDAR sensors 22 in a distributed manner.

The processor 12 detects an object that is present in the sensing range 120 based on the sensor data output from the LiDAR sensor 22.

The three-dimensional point cloud data output by the LiDAR sensor 22 includes information about the positions of a plurality of measurement points, and information (attribute information) about the reception intensity of a photodetector and the like. The information about the positions of a plurality of measurement points includes, for example, information about the emission direction of a laser pulse corresponding to a point, and information about the distance between the LiDAR sensor and the point. For example, the information about the positions of a plurality of measurement points also includes information about the coordinates of the points in a local coordinate system. The local coordinate system moves along with the vehicle 1, and is also referred to as a sensor coordinate system. The coordinates of each point can be calculated from the emission direction of a laser pulse corresponding to the point, and the distance between the LiDAR sensor and the point. As the unit of the local coordinate system, the SI unit of length is used, for example. When the coordinates of any two points are known, the length (meter) between the two points can be calculated.

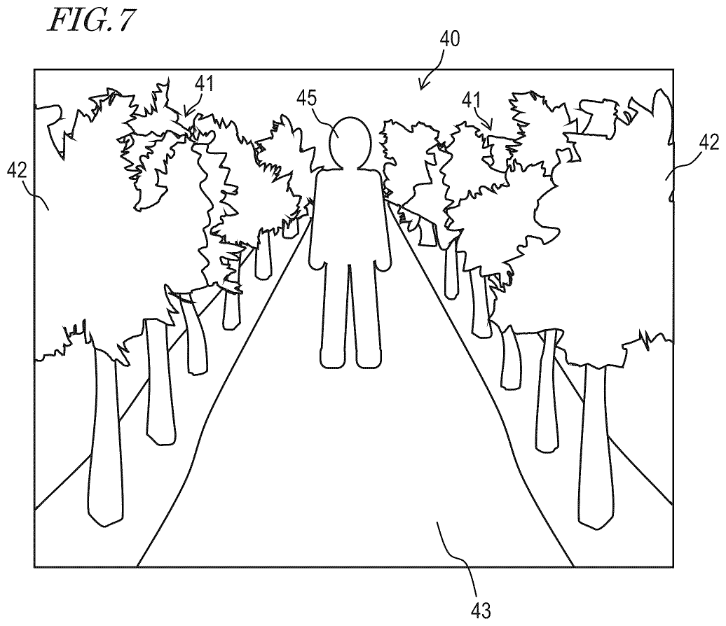

FIG. 7 is a diagram illustrating an example of an environment spreading out in front of the vehicle 1. In the example of FIG. 7, the vehicle 1 is positioned in the field 40, traveling on the ground 43 along the target path 46 (FIG. 4) set between tree rows 41. A human 45 is present in front of the vehicle 1. Laser pulses emitted by the LiDAR sensor 22 reach the tree rows 41, the ground 43, the human 45, and the like, and are reflected. By detecting the reflected light, three-dimensional point cloud data is obtained.

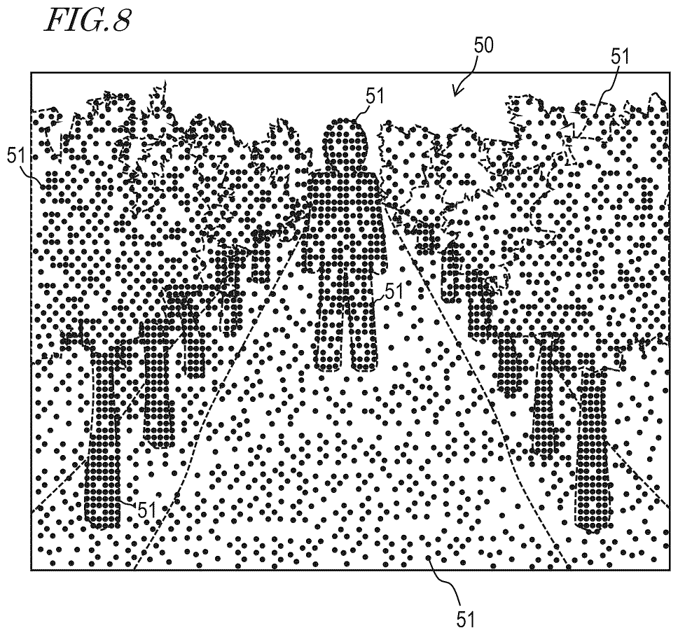

FIG. 8 is a diagram illustrating an example of a plurality of measurement points indicated by the three-dimensional point cloud data. FIG. 8 illustrates a plurality of measurement points 51 distributed in a three-dimensional space 50. In order to describe a relationship between objects to be measured that are present in an environment around the vehicle 1 (the tree rows 41, the ground 43, the human 45, etc.) and the plurality of measurement points 51 in an easy-to-understand manner, the plurality of measurement points 51 overlay the objects to be measured, as shown in FIG. 8.

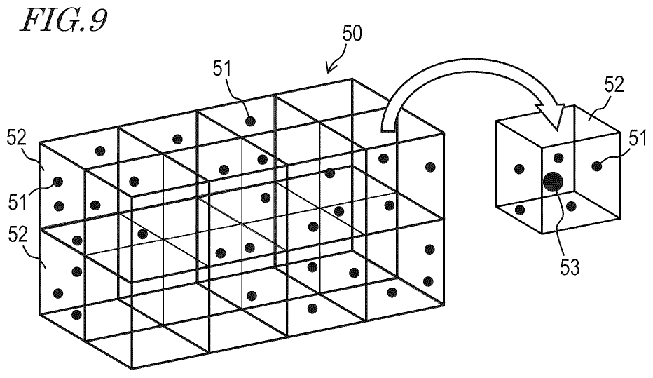

In the present preferred embodiment, a process is performed to divide the three-dimensional space 50 in which the plurality of measurement points 51 are distributed into a plurality of voxels. FIG. 9 is a diagram illustrating an example of the three-dimensional space 50 that is divided into a plurality of voxels 52. In the present preferred embodiment, the voxel 52 has a cubic shape, but may have other shapes. The length of each edge of the cube is, for example, but not limited to, at least 3 cm and at most 15 cm. The processor 12 (FIG. 3) performs the process of dividing the three-dimensional space 50 into the plurality of voxels 52.

The processor 12 extracts one of the plurality of voxels 52 that includes at least one measurement point 51. The processor 12 determines a representative point 53 from the at least one measurement point 51 included in the extracted voxel 52. For example, the processor 12 calculates the barycenter of the at least one measurement point 51 included in the extracted voxel 52, and sets the barycenter as the representative point 53 of that voxel 52. The calculated coordinates of the barycenter are the coordinates of the representative point 53. The processor 12 determines a representative point 53 for each extracted voxel 52.

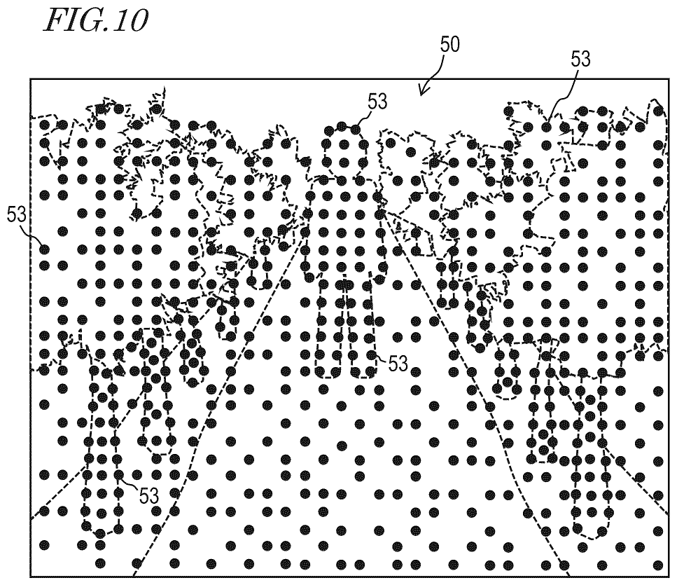

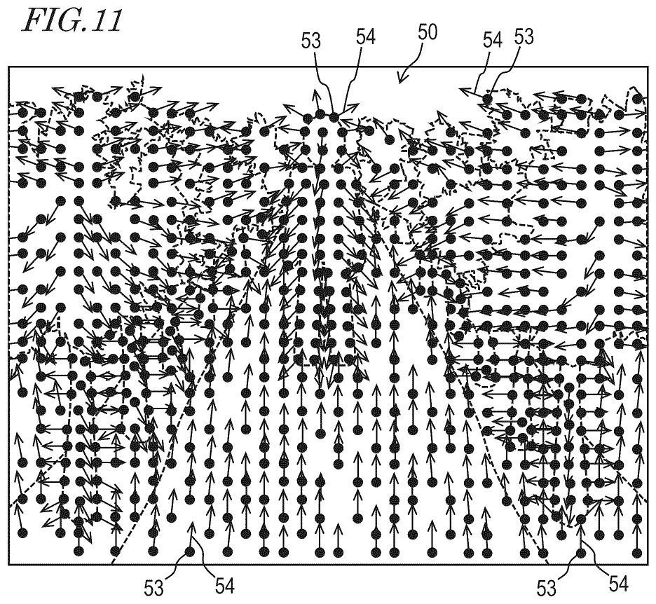

FIG. 10 is a diagram illustrating an example of the calculated representative points 53. In FIG. 10, the plurality of representative points 53 are distributed in the three-dimensional space 50. In FIG. 10, in order to describe a relationship between the plurality of representative points 53 and objects to be measured in an easy-to-understand manner, the plurality of representative points 53 overlay the objects to be measured. Likewise, in FIGS. 11 to 13 described below, a plurality of representative points 53 overlay objects to be measured.

In the present preferred embodiment, objects such as obstacles that are present around the vehicle 1 are detected using the calculated representative points 53. The total number of representative points 53 is smaller than the total number of measurement points 51 indicated by the three-dimensional point cloud data. Thus, the amount of calculation can be reduced by executing the process of detecting objects using the representative points 53 instead of the measurement points 51. A reduction in the amount of calculation allows for quicker detection of objects.

The processor 12 calculates a normal vector at each representative point 53. FIG. 11 is a diagram illustrating an example of a normal vector 54 at each calculated representative point 53. The normal vector can, for example, be calculated as follows. Two or more second representative points 53 that are present within a predetermined length range from a first representative point 53 are extracted. The predetermined length is, for example, but not limited to, at least 20 cm and at most 40 cm. The processor 12 calculates a plane that fits the first representative point 53 and the second representative points 53, and sets the normal vector of the plane as the normal vector of the first representative point 53. The plane can, for example, be calculated by the method of least squares.

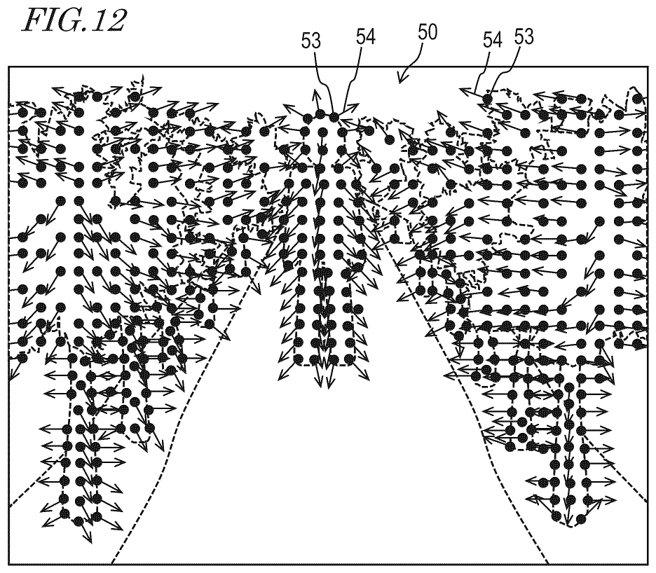

Next, the processor 12 executes a process of removing representative points 53 corresponding to a relatively flat ground. FIG. 12 is a diagram illustrating an example of representative points 53 that are left after removal of the representative points 53 corresponding to the relatively flat ground. The representative points 53 are mainly used to detect obstacles. The amount of calculation can be reduced by removing representative points 53 corresponding to a relatively flat ground, which is not considered as an obstacle.

For example, the processor 12 removes a representative point 53 for which the angle between a predetermined vector having a vertically upward direction and the normal vector 54 thereof is at most a predetermined threshold, which is considered as a representative point 53 corresponding to a relatively flat ground. A representative point 53 for which the angle between the predetermined vector having the vertically upward direction and the normal vector 54 thereof is greater than the predetermined threshold is not removed. The predetermined threshold is, for example, but not limited to, at least 20 degrees and at most 35 degrees. The tilt of the vehicle 1 can, for example, be calculated from the output signal of the IMU 26. The processor 12 can determine the vertically upward direction based on the output signal of the IMU 26. The angle between the predetermined vector having the vertically upward direction and the normal vector 54 can, for example, be calculated based on the definition of the inner product of vectors.

Next, the processor 12 performs clustering on the representative points 53 left after removal of the representative points 53 corresponding to the relatively flat ground. The processor 12 classifies two adjacent representative points 53 for which the angle between the normal vectors 54 thereof is at most a predetermined angle as belonging to the same group. When the angle between the normal vectors 54 of two adjacent representative points 53 is greater than the predetermined angle, the two representative points 53 are classified as belonging to different groups. The predetermined angle is, for example, but not limited to, at least 0 degrees and at most 30 degrees.

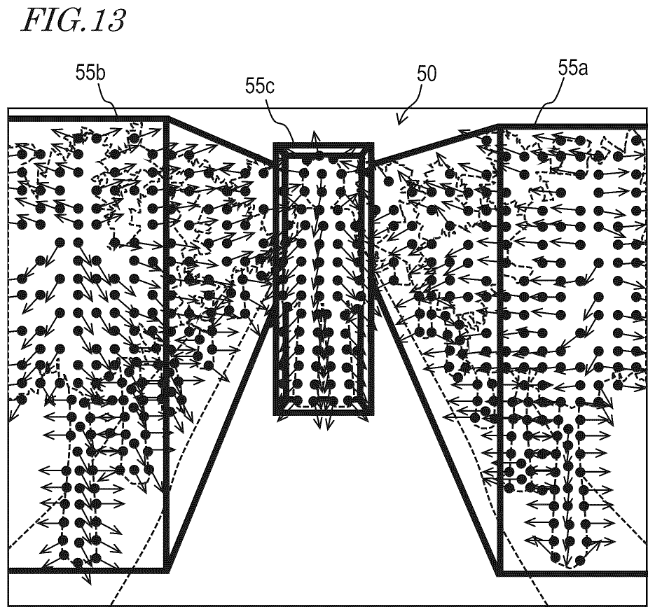

The processor 12 generates a three-dimensional bounding box that encloses representative points 53 belonging to the same group. For example, the processor 12 generates a bounding box by calculating three eigenvectors indicating the directions of the respective edges of the bounding box. A technique of generating a bounding box is known and is not herein described. FIG. 13 is a diagram illustrating an example of a bounding box. In the example of FIG. 13, bounding boxes 55a and 55b for tree rows 41 and a bounding box 55c for a human 45 are generated. Each bounding box 55 is given an ID (identification information).

The processor 12 repeatedly executes a process of generating a bounding box from three-dimensional point cloud data at predetermined time intervals (e.g., 100 msec). The processor 12 compares at least one bounding box previously generated with at least one bounding box currently generated, assigns the same ID to bounding boxes positioned close to each other, and performs tracking. As a result, the movement direction and movement speed of an object corresponding to a bounding box can be estimated. The processor 12 monitors objects that are relatively approaching the vehicle 1, and when determining that an object is highly likely to be brought into contact with the vehicle 1, may perform a control including reducing the travel speed of the vehicle 1, halting the vehicle 1, and steering to avoid contact with the object. In addition, when the processor 12 detects an object that is present within a predetermined distance range in front of the vehicle 1, the processor 12 may perform a control including reducing the travel speed of the vehicle 1, halting the vehicle 1, and steering to avoid contact with the object.

As described above, an object that is present in the sensing range 120 can be detected using the three-dimensional point cloud data output by the LiDAR sensor 22. Meanwhile, there may be a dead zone in which data of a sufficient number of measurement points 51 to detect an object is not obtained, in a region near a LiDAR sensor, i.e., a region within a distance of several tens of centimeters from the sensor. For example, in a region within a distance of less than 50 cm from a LiDAR sensor, data of a sufficient number of measurement points 51 to detect an object may not be obtained.

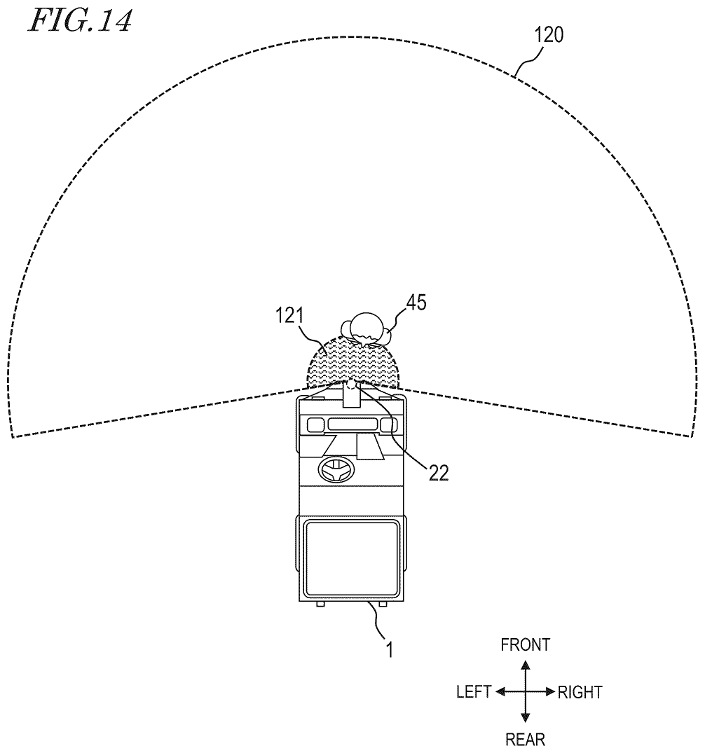

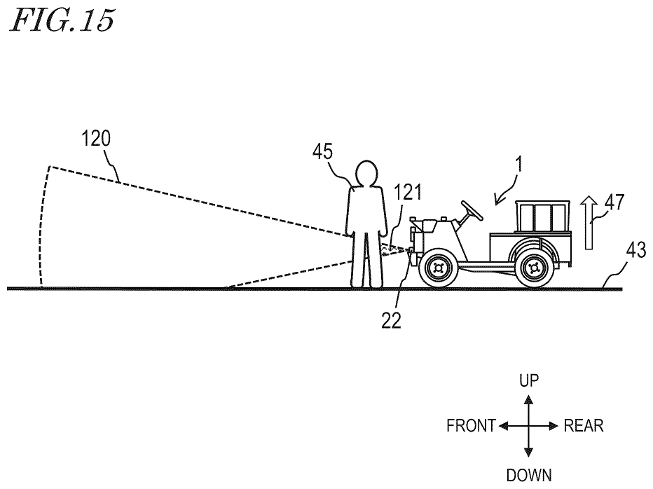

FIG. 14 is a diagram illustrating an example of a dead zone 121 as viewed from above in a height direction thereof. FIG. 15 is a diagram illustrating an example of the dead zone 121 as viewed from a side thereof in a direction parallel to the left-right direction of the vehicle 1. When an object such as the human 45 is present in the dead zone 121, data of measurement points 51 in a range in which the object is present may not be obtained or only a small portion thereof may be obtained, and therefore, it may be difficult to detect the object.

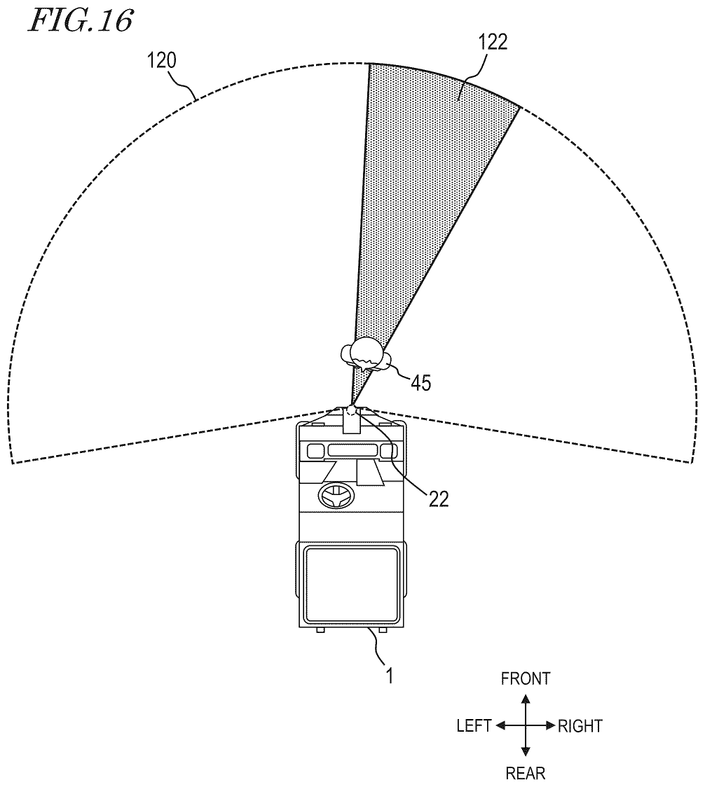

When an object is present in the dead zone 121, laser pulses emitted from the LiDAR sensor 22 in the direction of the object are reflected by the surface of the object, but no measurement points 51 can be detected or only a small number of measurement points 51 can be detected. Laser pulses do not reach an object that is present behind that object as viewed from the LiDAR sensor 22, and therefore, there is a range in which data of a sufficient number of measurement points 51 is not obtained in the sensing range 120. FIG. 16 is a diagram illustrating an example of a range 122 in which data of a sufficient number of measurement points 51 is not obtained. In the example of FIG. 16, when the legs of the human 45 are present in the dead zone 121, data of a sufficient number of measurement points 51 is not obtained in an angular range in which the legs of the human 45 are present. When data of a sufficient number of measurement points 51 is not obtained, a sufficient number of representative points 53 are not obtained. When an object is present in the dead zone 121, it is difficult to detect the object using the three-dimensional point cloud data output by the LiDAR sensor 22.

In the present preferred embodiment, when an object is present in the dead zone 121, the range 122 in which data of a sufficient number of measurement points 51 is not obtained occurs. Such a situation may be advantageously used. When the occurrence of the range 122 is detected, the vehicle 1 is controlled into a travel stopped state. As a result, even when an object is present in the vicinity of the vehicle 1, and is also present in the dead zone 121 of the LiDAR sensor 22, so that data of a sufficient number of measurement points 51 to detect the object is not obtained, the vehicle 1 is prevented from continuing to travel.

The processor 12 obtains data of a plurality of measurement points 51 from the three-dimensional point cloud data. The processor 12 projects the plurality of measurement points 51 onto a plane that is parallel to the front-back and left-right directions of the vehicle 1 to generate two-dimensional data. Using the two-dimensional data thus generated, the processor 12 determines whether or not there is any range 122 in which no or only a small number of measurement points 51 are present.

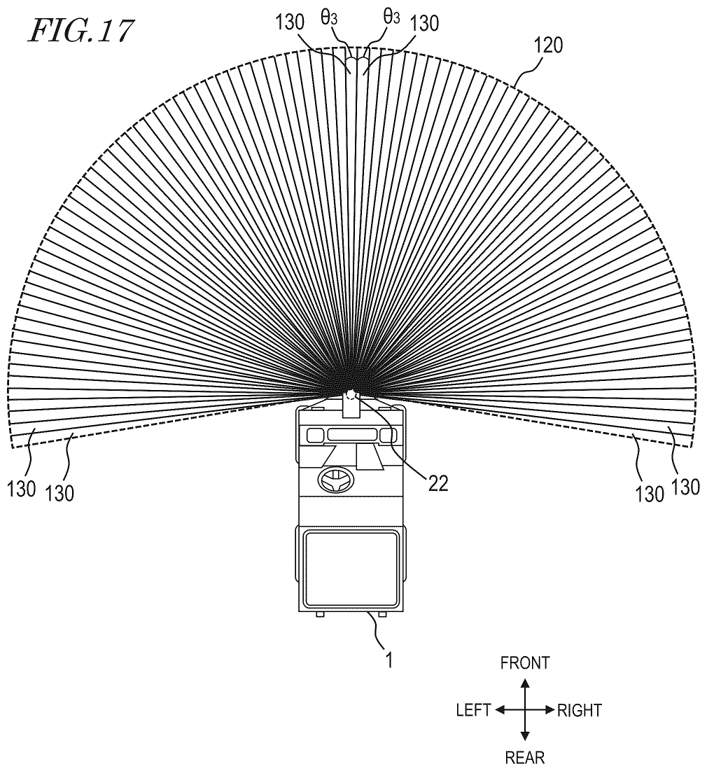

The processor 12 counts the number of measurement points 51 in each predetermined angular range as viewed from above in a height direction 47 of the vehicle 1. FIG. 17 is a diagram illustrating an example of predetermined angular ranges. The processor 12 divides the plane on which the plurality of measurement points 51 are projected into a plurality of areas 130 each having the predetermined angular range. The processor 12 counts the number of measurement points 51 in each area 130. A predetermined angle θ₃ of each area 130 is, for example, but not limited to, at least one degree and at most two degrees. By counting the number of measurement points 51 in each relatively narrow angular range, a range in which only a small number of measurement points 51 are present can be identified with high precision.

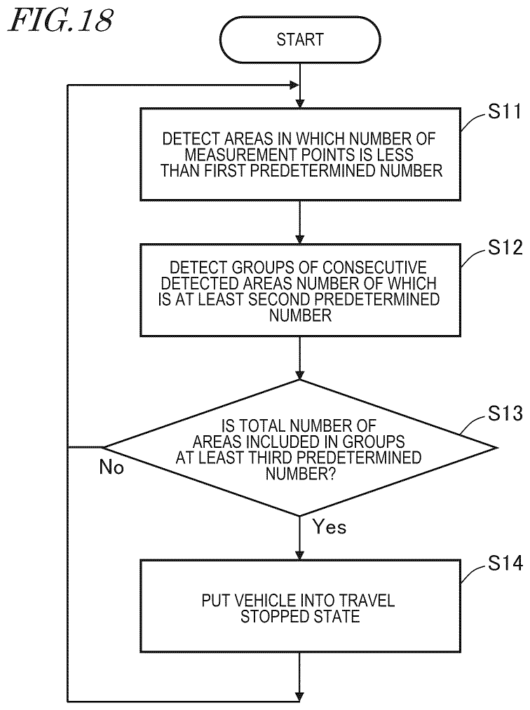

FIG. 18 is a flowchart illustrating an example of a control to put the vehicle 1 into the travel stopped state depending on the counted number of measurement points 51.

The processor 12 counts the number of measurement points 51 in each area 130, and detects an area(s) 130 in which the counted number of measurement points 51 is less than a first predetermined number (step S11). The first predetermined number is, for example, but not limited to, at least two and at most five.

Next, when there are consecutive areas 130 in each of which the number of measurement points 51 is less than the first predetermined number, and the number of the consecutive areas 130 is at least a second predetermined number, the processor 12 detects the consecutive areas the number of which is at least the second predetermined number, as a group 135 (step S12). The second predetermined number is, for example, but not limited to, at least two and at most five. When there are no such consecutive areas 130 the number of which is at least the second predetermined number, no group 135 is detected.

Next, the processor 12 determines whether or not the total number of areas 130 included in at least one detected group 135 is at least a third predetermined number (step S13). When a plurality of groups 135 are detected, the processor 12 determines whether or not the total number of areas 130 included in all of the groups 135 is at least the third predetermined number. The third predetermined number, which is a threshold, is, for example, but not limited to, at least 6 and at most 10. For example, the third predetermined number may be more than 10. When the total number is less than the third predetermined number, the control returns to step S11. When no group 135 is detected in step S12, the total number of areas 130 is considered to be zero, and the control returns to step S11. The processor 12 repeatedly executes steps S11 to S13.

When the total number of areas 130 included in the at least one detected group 135 is at least the third predetermined number, the processor 12 perform a control to put the vehicle 1 into the travel stopped state (step S14).

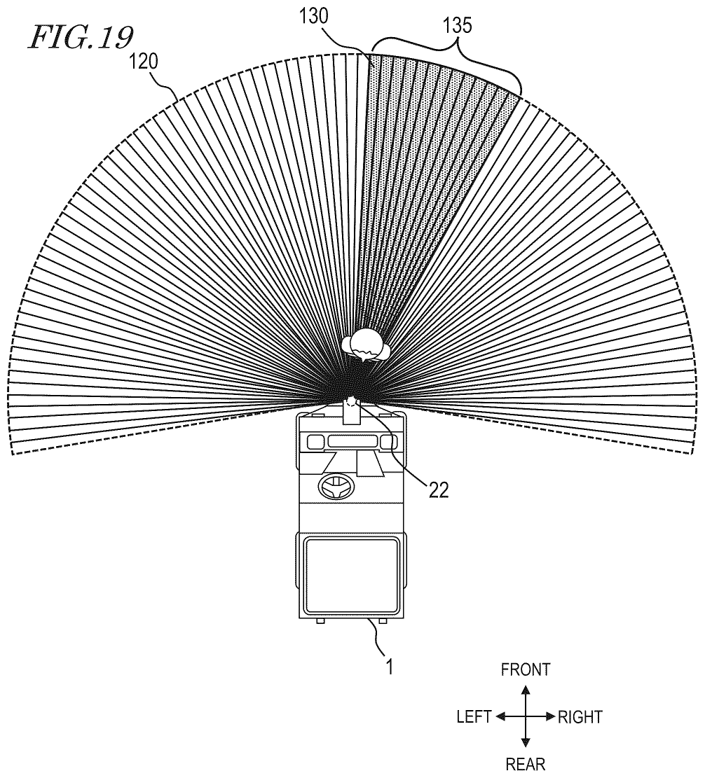

FIG. 19 is a diagram illustrating an example of a state in which the total number of areas 130 included in at least one detected group 135 is at least the third predetermined number. In the example of FIG. 19, the total number of areas 130 included in one detected group 135 is at least the third predetermined number.

For example, in the case in which the third predetermined number is eight, then when the total number of areas 130 included in at least one detected group 135 is at least eight, a control is performed so as to put the vehicle 1 into the travel stopped state. When a single human is present very close to the LiDAR sensor 22, or a plurality of humans are present in the dead zone 121, the total number of areas 130 included in at least one detected group 135 may be several tens to several hundreds. In this case, the total number of areas 130 included in at least one detected group 135 is at least the third predetermined number, and therefore, a control is performed so as to put the vehicle 1 into the travel stopped state.

When the total number of areas 130 included in at least one detected group 135 is at least the third predetermined number, the processor 12 transmits, to the ECU 16, an instruction to put the vehicle 1 into the travel stopped state. The ECU 16, when receiving the instruction, controls operations of the engine 31 and the brake device of the drive device 30 so as to put the vehicle 1 into the travel stopped state. When the vehicle 1 is traveling, the vehicle 1 is caused to stop. When the vehicle 1 is not moving, the vehicle 1 is maintained at rest.

As described above, in the present preferred embodiment, the number of measurement points 51 is counted in each predetermined angular range, and a control is performed so as to put the vehicle 1 into the travel stopped state depending on the counted number of measurement points 51. As a result, the vehicle 1 is prevented from continuing to travel even when an object is present in the vicinity of the vehicle 1 but the object is present in the dead zone 121 of the LiDAR sensor 22, and therefore, data of a sufficient number of measurement points 51 to detect the object is not obtained.

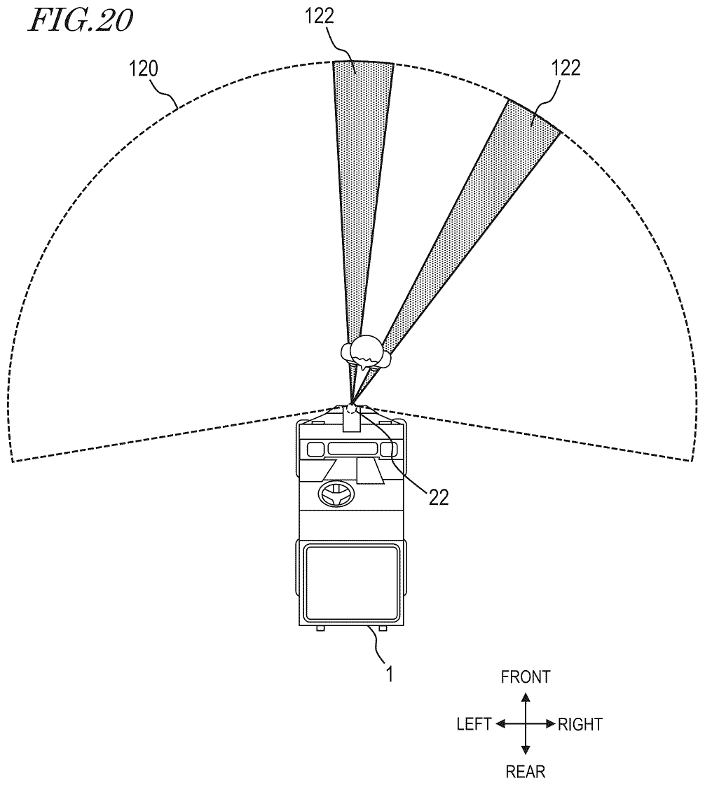

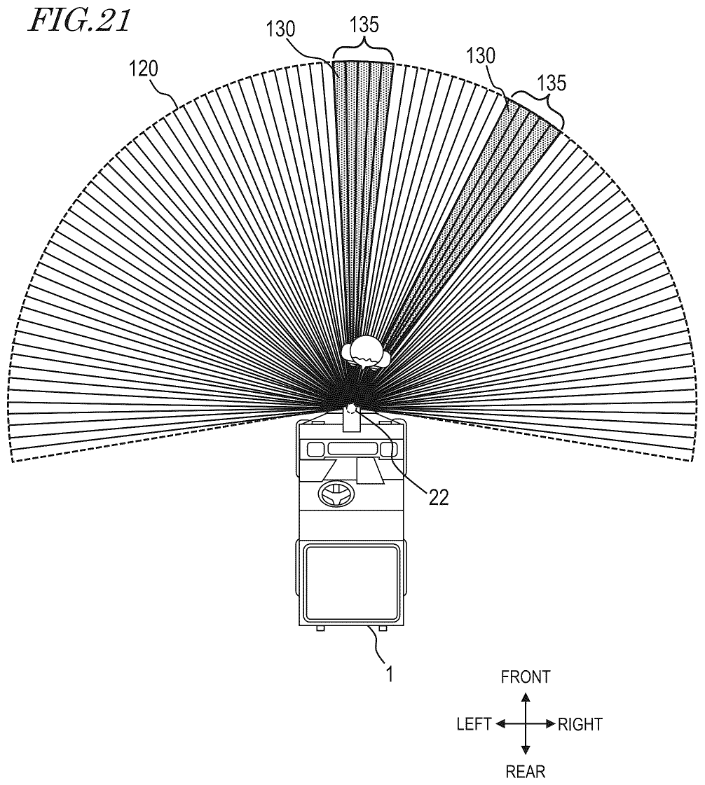

FIG. 20 is a diagram illustrating another example of a range 122 in which data of a sufficient number of measurement points 51 is not obtained. FIG. 21 is a diagram illustrating another example of a state in which the total number of areas 130 included in at least one detected group 135 is at least the third predetermined number. In the example of FIG. 20, laser pulses pass through a space between the left and right legs of a human 45, and therefore, data of a sufficient number of measurement points 51 is obtained in an area extending from the LiDAR sensor 22 through the space between the left and right legs of the human 45. In an angular range in which the right leg of the human 45 is present and an angular range in which the left leg of the human 45 is present, data of a sufficient number of measurement points 51 is not obtained. The total number of areas 130 included in one group 135 may be less than the third predetermined number depending on the lateral width of one leg of the human 45.

In the present preferred embodiment, even when the total number of areas 130 included in one group 135 is less than the third predetermined number, then if the total number of areas 130 included in two or more groups 135 is at least the third predetermined number, a control is performed so as to put the vehicle 1 into the travel stopped state. As a result, even when laser pulses pass through a space between the left and right legs of the human 45, the vehicle 1 is prevented from continuing to travel.

As described above, in step S12, a group 135 of consecutive areas 130 in which the number of measurement points 51 is less than the first predetermined number, and the number of which is at least the second predetermined number, is detected. As a result, the vehicle 1 is prevented from being put into the travel stopped state when there is only one area or only a small number of consecutive areas 130 in which the number of measurement points 51 is less than the first predetermined number due to noise or the like.

In step S13, when the total number of areas 130 included in all detected groups 135 is at least the third predetermined number, the processor 12 performs a control to put the vehicle 1 into the travel stopped state. When the total number of areas 130 included in all detected groups 135 is less than the third predetermined number, a control to put the vehicle 1 into the travel stopped state is not performed. As a result, the vehicle 1 is prevented from being put into the travel stopped state when there are only a small number of areas 130 in which the number of measurement points 51 is less than the first predetermined number due to noise or the like.

After control is performed so as to put the vehicle 1 into the travel stopped state in step S14, the processor 12 repeatedly executes steps S11 to S13. When the state in which the total number of areas 130 included in all detected groups 135 is at least the third predetermined number is continued, the vehicle 1 is maintained in the travel stopped state. When the total number of areas 130 included in all detected groups 135 is less than the third predetermined number, a control to put the vehicle 1 into the travel stopped state will be ended, and a control to cause the vehicle 1 to resume traveling will be performed.

It should be noted that when it is necessary to put the vehicle 1 into the travel stopped state according to another process different from that of FIG. 18, the vehicle 1 is, of course, not caused to travel.

As described above, in the present preferred embodiment, the vehicle 1 is prevented from continuing to travel even when data of a sufficient number of measurement points 51 is not obtained to detect an object in the dead zone 121.

Next, a control to put the vehicle 1 into the travel stopped state, depending on the counted number of representative points 53, will be described. Although in the above process the vehicle 1 is put into the travel stopped state, depending on the counted number of measurement points 51, the vehicle 1 may be put into the travel stopped state depending on the counted number of representative points 53.

As illustrated with reference to FIGS. 9 and 10, the processor 12 obtains a plurality of representative points 53 using the three-dimensional point cloud data. The processor 12 projects the plurality of representative points 53 onto a plane parallel to the front-back and left-right directions of the vehicle 1 to generate two-dimensional data. Using the two-dimensional data thus generated, the processor 12 determines whether or not there is any range 122 in which no or only a small number of representative points 53 are present.

In this example, the processor 12 counts the number of representative points 53 in each predetermined angular range as viewed from above in the height direction 47 of the vehicle 1. As described above with reference to FIG. 17, the processor 12 divides the plane on which the plurality of representative points 53 are projected into a plurality of areas 130 each having the predetermined angular range. The processor 12 counts the number of representative points 53 in each area 130.

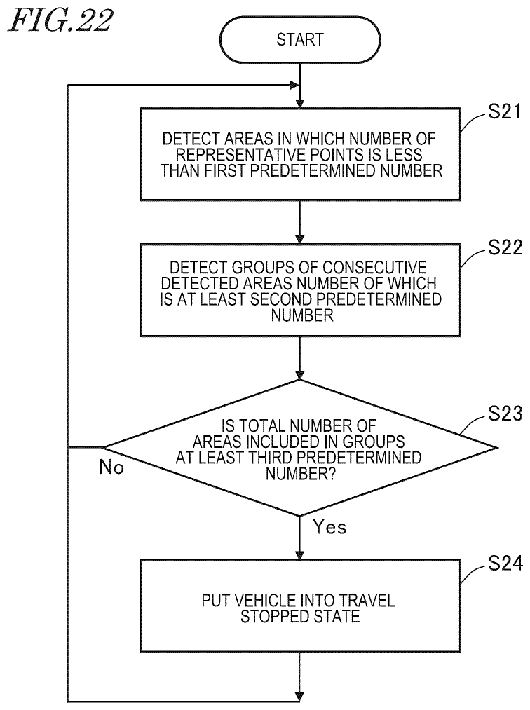

FIG. 22 is a flowchart illustrating an example of a control to put the vehicle 1 into the travel stopped state depending on the counted number of representative points 53.

The processor 12 counts the number of representative points 53 in each area 130, and detects an area(s) 130 in which the counted number of representative points 53 is less than a first predetermined number (step S21). The first predetermined number is, for example, but not limited to, at least two and at most five.

Next, when there are consecutive areas 130 in each of which the number of representative points 53 is less than the first predetermined number, and the number of the consecutive areas 130 is at least a second predetermined number, the processor 12 detects the consecutive areas the number of which is at least the second predetermined number as a group 135 (step S22).

Next, the processor 12 determines whether or not the total number of areas 130 included in at least one detected group 135 is at least a third predetermined number (step S23). When the total number is less than the third predetermined number, the control returns to step S21.

When the total number of areas 130 included in the at least one detected group 135 is at least the third predetermined number, the processor 12 perform a control to put the vehicle 1 into the travel stopped state (step S24).

In this example, the number of representative points 53 is counted in each predetermined angular range, and a control is performed so as to put the vehicle 1 into the travel stopped state depending on the counted number of representative points 53. As a result, the vehicle 1 is prevented from continuing to travel even when an object is present in the vicinity of the vehicle 1 but the object is present in the dead zone 121 of the LiDAR sensor 22, and therefore, data of a sufficient number of measurement points 51 to detect the object is not obtained.

The travel control system 10 of the present preferred embodiment can be additionally attached to a vehicle 1 that does not have the functions of a travel control system. Such a system may be produced and sold separately from the vehicle 1. A computer program that is used in such a system may be produced and sold separately from the vehicle 1. The computer program may be stored and provided in, for example, a non-transitory computer-readable storage medium. The computer program may be downloaded and provided through an electrical communication line (e.g., the Internet).

All or a portion of the process executed by the processor 12 in the travel control system 10 may be executed by other devices. Such other devices may be at least one of a processor of the server computer 111 or a processor of the terminal device 112. In that case, a processor of such other devices may be included in the control device of the travel control system 10.

In the foregoing description of preferred embodiments of the present invention, a control that is performed when an object is present in the dead zone of a LiDAR sensor has been described. In addition to LiDAR sensors, the control is also applicable to other sensors that sense an environment around a vehicle.

In the foregoing description, some illustrative preferred embodiments of the present invention have been described. The present description discloses travel control systems, travel control methods, and non-transitory computer readable mediums including computer programs.

According to a preferred embodiment of the present invention, a travel control system 10 for controlling traveling of a vehicle 1 includes a sensor 22 to sense an environment around the vehicle 1 and output sensor data, and a control device 11 configured or programmed to detect an object around the vehicle 1 based on the sensor data, and control traveling of the vehicle 1 depending on a result of the object detection, wherein the sensor data includes three-dimensional point cloud data, and the control device 11 is configured or programmed to obtain data of a plurality of points 51 from the three-dimensional point cloud data, count a number of the points 51 in each of a plurality of predetermined angular ranges as viewed from above in a height direction of the vehicle 1, and perform a control to put the vehicle 1 into a travel stopped state depending on the counted number of points 51.

In the vicinity of the sensor 22, there may be a dead zone 121 in which data of a sufficient number of points 51 to detect an object is not obtained. When an object is present in such a dead zone 121, none or only a small amount of data of points 51 may be obtained in a range in which the object is present, and therefore, it may be difficult to detect the object.

According to a preferred embodiment of the present invention, the number of points 51 is counted in each of the plurality of predetermined angular ranges, and a control is performed so as to put the vehicle 1 into the travel stopped state depending on the counted number of points 51. For example, when the number of points 51 is small, the vehicle 1 is not permitted to travel and is caused to stop traveling. When the vehicle 1 is not moving, the vehicle 1 is maintained at rest.

As a result, the vehicle 1 is prevented from continuing to travel even when an object is present in the vicinity of the vehicle 1 but the object is present in the dead zone 121 of the sensor 22, and therefore, data of a sufficient number of points 51 to detect the object is not obtained. In a travel control system 10 according to a preferred embodiment of the present invention, the control device 11 is configured or programmed to detect an area 130 having the predetermined angular range in which the counted number of points 51 is less than a first predetermined number, detect a group 135 including consecutive ones of the detected areas 130 in which a number of the consecutive ones is at least a second predetermined number, and perform a control to put the vehicle 1 into the travel stopped state when the total number of the areas 130 included in the detected group or groups 135 is at least a third predetermined number.

By using the number of consecutive areas 130 having a predetermined angular range in which a small number of points 51 are present, the vehicle 1 is prevented from being put into the travel stopped state when there are only a small number of consecutive areas 130 due to noise or the like.

When the total number of areas 130 having a predetermined angular range in which a small number of points 51 are present is at least the third predetermined number, a control is performed so as to put the vehicle 1 into the travel stopped state. As a result, the vehicle 1 is prevented from continuing to travel even when data of a sufficient number of points 51 to detect an object in the dead zone 121 is not obtained.

In a travel control system 10 according to a preferred embodiment of the present invention, the control device 11 is configured or programmed to perform a control to put the vehicle 1 into the travel stopped state when the total number of the areas 130 included in one of the detected groups 135 is at least the third predetermined number.

When the number of consecutive areas 130 having a predetermined angular range in which a small number of points 51 are present is at least the third predetermined number, the control is performed so as to put the vehicle 1 into the travel stopped state. As a result, the vehicle 1 is prevented from continuing to travel even when data of a sufficient number of points 51 to detect an object in the dead zone 121 is not obtained.

In a travel control system 10 according to a preferred embodiment of the present invention, the control device 11 is configured or programmed to perform a control to put the vehicle 1 into the travel stopped state when the total number of the areas 130 included in at least two of the detected groups 135 is at least the third predetermined number.

By using the total number of areas 130 having a predetermined angular range in which a small number of points 51 are present, the vehicle 1 is prevented from continuing to travel even when there are two or more separate groups of such areas 130 due to the shape of an object, the position that an object adopts, and the like.

In a travel control system 10 according to a preferred embodiment of the present invention, the control device 11 is configured or programmed to not perform a control to put the vehicle 1 into the travel stopped state, depending on the counted number of points 51, when the group 135 is not detected.

As a result, the vehicle 1 is prevented from being put into the travel stopped state when there is only one area or only a small number of consecutive areas 130 in which the number of points 51 is small due to noise or the like.

In a travel control system 10 according to a preferred embodiment of the present invention, the control device 11 is configured or programmed to not perform a control to put the vehicle 1 into the travel stopped state, depending on the counted number of points 51, when the total number of the areas 130 included in all of the detected groups 135 is less than the third predetermined number.

As a result, the vehicle 1 is prevented from being put into the travel stopped state when there are only a small number of areas 130 in which the number of points 51 is small due to noise or the like.

In a travel control system 10 according to a preferred embodiment of the present invention, the control device 11 is configured or programmed to obtain data of a plurality of measurement points 51 indicated by the three-dimensional point cloud data as the data of the plurality of points, count a number of the measurement points 51 in each predetermined angular range as viewed from above, and perform a control to put the vehicle 1 into the travel stopped state depending on the counted number of measurement points 51.

The vehicle 1 is prevented from continuing to travel even when an object is present in the vicinity of the vehicle 1 but the object is present in the dead zone 121 of the sensor 22, and therefore, data of a sufficient number of points 51 to detect the object is not obtained.

In a travel control system 10 according to a preferred embodiment of the present invention, the control device 11 is configured or programmed to divide a space in which the plurality of measurement points 51 indicated by the three-dimensional point cloud data are distributed into a plurality of voxels 52, determine a representative point 53 for each voxel 52 in which at least one of the measurement point 51 is present, obtain data of the plurality of representative points 53 as the data of the plurality of points, count the number of the representative points 53 that are present in each predetermined angular range as viewed from above, and perform a control to put the vehicle 1 into the travel stopped state depending on the counted number of representative points 53.

The vehicle 1 is prevented from continuing to travel even when an object is present in the vicinity of the vehicle 1 but the object is present in the dead zone 121 of the sensor 22, and therefore, data of a sufficient number of points 51 to detect the object is not obtained.

In a travel control system 10 according to a preferred embodiment of the present invention, the sensor 22 is a LiDAR sensor.

The vehicle 1 is prevented from continuing to travel even when an object is present in the vicinity of the vehicle 1 but the object is present in the dead zone 121 of the LiDAR sensor 22, and therefore, data of a sufficient number of points 51 to detect the object is not obtained.

A vehicle 1 according to a preferred embodiment of the present invention includes the travel control system 10 according to a preferred embodiment of the present invention.

The vehicle 1 is prevented from continuing to travel even when an object is present in the vicinity of the vehicle 1 but the object is present in the dead zone 121 of the sensor 22, and therefore, data of a sufficient number of points 51 to detect the object is not obtained.

In a vehicle 1 according to a preferred embodiment of the present invention, the vehicle 1 is a mobile agricultural machine.

The vehicle 1 is prevented from continuing to travel even when an object is present in the vicinity of the vehicle 1 during work in a field but the object is present in the dead zone 121 of the sensor 22, and therefore, data of a sufficient number of points 51 to detect the object is not obtained.

In a vehicle 1 according to a preferred embodiment of the present invention, the vehicle 1 further includes a drive device 30 to cause the vehicle 1 to travel, wherein the control device 11 is configured or programmed to control operation of the drive device 30 so as to cause the vehicle 1 to perform autonomous driving.

The vehicle 1 that performs autonomous driving is prevented from continuing to travel even when an object is present in the vicinity of the vehicle 1 but the object is present in the dead zone 121 of the sensor 22, and therefore, data of a sufficient number of points 51 to detect the object is not obtained.

In a travel control system 10 according to a preferred embodiment of the present invention, the predetermined angular range is at least one degree and at most two degrees.

The number of points 51 is counted in each relatively narrow angular range, and therefore, a range in which the number of points 51 is small can be identified with high precision.

In a travel control system 10 according to a preferred embodiment of the present invention, the first predetermined number is at least two and at most five.

As a result, an area 130 having a predetermined angular range in which the number of points 51 is small can be detected.

In a travel control system 10 according to a preferred embodiment of the present invention, the second predetermined number is at least two and at most five.

As a result, the vehicle 1 is prevented from being put into the travel stopped state when there are only a small number of consecutive areas 130 having a predetermined angular range in which the number of points 51 is small due to noise or the like.

In a travel control system 10 according to a preferred embodiment of the present invention, the third predetermined number is at least six.

A control is performed so as to put the vehicle 1 into the travel stopped state depending on the total number of areas 130 having a predetermined angular range in which the number of points 51 is small. Therefore, the vehicle 1 is prevented from continuing to travel even when data of a sufficient number of points to detect an object present in the dead zone 121 is not obtained.

According to a preferred embodiment of the present invention, a travel control method for controlling traveling of a vehicle 1 including a sensor 22 to sense an environment around the vehicle 1 and output sensor data including three-dimensional point cloud data includes obtaining data of a plurality of points 51 from the three-dimensional point cloud data, counting a number of the points 51 in each predetermined angular range as viewed from above in a height direction of the vehicle 1, and performing a control to put the vehicle 1 into a travel stopped state depending on the counted number of points 51.

In the vicinity of the sensor 22, there may be a dead zone 121 in which data of a sufficient number of points 51 to detect an object is not obtained. When an object is present in such a dead zone 121, none or only a small amount of data of points 51 may be obtained in a range in which the object is present, and therefore, it may be difficult to detect the object.

According to a preferred embodiment of the present invention, the number of points 51 is counted in each predetermined angular range, and a control is performed so as to put the vehicle 1 into the travel stopped state depending on the counted number of points 51. For example, when the number of points 51 is small, the vehicle 1 is not permitted to travel and is caused to stop traveling. When the vehicle 1 is not moving, the vehicle 1 is maintained at rest.

As a result, the vehicle 1 is prevented from continuing to travel even when an object is present in the vicinity of the vehicle 1 but the object is present in the dead zone 121 of the sensor 22, and therefore, data of a sufficient number of points 51 to detect the object is not obtained.

According to a preferred embodiment of the present invention, a non-transitory computer readable medium including a computer program to cause a computer to execute a process of controlling traveling of a vehicle 1, which includes a sensor 22 to sense an environment around the vehicle 1 and output sensor data including three-dimensional point cloud data, includes obtaining data of a plurality of the points 51 from the three-dimensional point cloud data, counting a number of the points 51 that are present in each predetermined angular range as viewed from above in a height direction of the vehicle 1, and performing a control to put the vehicle 1 into a travel stopped state depending on the counted number of points 51.

In the vicinity of the sensor 22, there may be a dead zone 121 in which data of a sufficient number of points 51 to detect an object is not obtained. When an object is present in such a dead zone 121, none or only a small amount of data of points 51 may be obtained in a range in which the object is present, and therefore, it may be difficult to detect the object.

According to a preferred embodiment of the present invention, the number of points 51 is counted in each predetermined angular range, and a control is performed so as to put the vehicle 1 into the travel stopped state depending on the counted number of points 51. For example, when the number of points 51 is small, the vehicle 1 is not permitted to travel and is caused to stop traveling. When the vehicle 1 is not moving, the vehicle 1 is maintained at rest.

As a result, the vehicle 1 is prevented from continuing to travel even when an object is present in the vicinity of the vehicle 1 but the object is present in the dead zone 121 of the sensor 22, and therefore, data of a sufficient number of points 51 to detect the object is not obtained.

The techniques of preferred embodiments of the present disclosure are particularly useful in the field of travel control of a vehicle.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A travel control system for controlling traveling of a vehicle, the travel control system comprising:
a sensor to sense an environment around the vehicle and output sensor data; and
a controller configured or programmed to detect an object around the vehicle based on the sensor data, and to control traveling of the vehicle depending on a result of the object detection; wherein
the sensor data includes three-dimensional point cloud data; and
the controller is configured or programmed to:
obtain data of a plurality of points from the three-dimensional point cloud data;
count a number of the point(s) in each of a plurality of predetermined angular ranges as viewed from above in a height direction of the vehicle; and
perform a control to put the vehicle into a travel stopped state depending on the counted number of points.

2. The travel control system according to claim 1, wherein the controller is configured or programmed to:
detect an area having the predetermined angular range in which the counted number of points is less than a first predetermined number;
detect a group including consecutive ones of the detected areas in which a number of the consecutive ones is at least a second predetermined number; and
perform a control to put the vehicle into the travel stopped state when a total number of the areas included in the detected group or groups is at least a third predetermined number.

3. The travel control system according to claim 2, wherein the controller is configured or programmed to perform a control to put the vehicle into the travel stopped state when the total number of the areas included in one of the detected groups is at least the third predetermined number.

4. The travel control system according to claim 2, wherein the controller is configured or programmed to perform a control to put the vehicle into the travel stopped state when the total number of the areas included in at least two of the detected groups is at least the third predetermined number.

5. The travel control system according to claim 2, wherein the controller is configured or programmed to not perform a control to put the vehicle into the travel stopped state, depending on the counted number of points, when the group is not detected.

6. The travel control system according to claim 2, wherein the controller is configured or programmed to not perform a control to put the vehicle into the travel stopped state, depending on the counted number of points, when the total number of the areas included in all of the detected groups is less than the third predetermined number.

7. The travel control system according to claim 1, wherein the controller is configured or programmed to:
obtain data of a plurality of measurement points indicated by the three-dimensional point cloud data as the data of the plurality of points;
count the number of the measurement points in each of the plurality of predetermined angular ranges as viewed from above; and
perform a control to put the vehicle into the travel stopped state depending on the counted number of measurement points.

8. The travel control system according to claim 1, wherein the controller is configured or programmed to:
divide a space in which the plurality of measurement points indicated by the three-dimensional point cloud data are distributed into a plurality of voxels;
determine a representative point for each of the plurality of voxels in which at least one of the measurement points is present;
obtain data of the plurality of representative points as the data of the plurality of points;
count a number of the representative points that are present in each of the plurality of predetermined angular ranges as viewed from above; and
perform a control to put the vehicle into the travel stopped state depending on the counted number of representative points.

9. The travel control system according to claim 1, wherein the sensor is a LiDAR sensor.

10. A vehicle comprising:
the travel control system according to claim 1.

11. The vehicle according to claim 10, wherein the vehicle is a mobile agricultural machine.

12. The vehicle according to claim 10, further comprising:
a drive to cause the vehicle to travel; wherein
the controller is configured or programmed to control operation of the drive so as to cause the vehicle to perform autonomous driving.

13. A travel control method for controlling traveling of a vehicle including a sensor to sense an environment around the vehicle and output sensor data including three-dimensional point cloud data, the method comprising:
obtaining data of a plurality of points from the three-dimensional point cloud data;
counting a number of the points in each of the plurality of predetermined angular ranges as viewed from above in a height direction of the vehicle; and
performing control to put the vehicle into a travel stopped state depending on the counted number of points.

14. A non-transitory computer readable medium including a computer program to cause a computer to execute a process of controlling traveling of a vehicle including a sensor to sense an environment around the vehicle and output sensor data including three-dimensional point cloud data, the process of controlling traveling of the vehicle comprising:
obtaining data of a plurality of points from the three-dimensional point cloud data;
counting a number of the points that are present in each of a plurality of predetermined angular ranges as viewed from above in a height direction of the vehicle; and
performing a control to put the vehicle into a travel stopped state depending on the counted number of points.
